(19) United States
(12) Patent Application Publication
(10) Pub. No.: US 2011/0166039 A1
(43) Pub. Date: Jul. 7, 2011

(54) Methods of Discovering or Developing Novel Materials and Molecules

(76) Inventors: Yongchun Tang, Walnut, CA (US); William A. Goddard, III, Pasadena, CA (US); Roy Periana, Jupiter, FL (US)

(21) Appl. No.: 11/628,258

(22) PCT Filed: Jun. 3, 2005
(86) PCT No.: PCT/US05/19521

§ 371 Date: Oct. 29, 2007

Related U.S. Application Data
(60) Provisional application No. 60/576,482, filed on Jun. 3, 2004.

(51) Int. Cl. C40B 30/08

(52) U.S. Cl. 506/11

(57) ABSTRACT

The present inventions relates to methods of discovering or developing novel material or compound. In particular, the methods include the steps of using of general expert knowledge to identify currently available molecules, setting forth desired properties for a target molecule, designing a set of test molecule from the currently available molecule using computational methods (the test molecules having desired properties in the computational models); synthesizing the test molecules, testing the test molecules in real experiments, and identifying the target molecule which is the test molecule that has the desired properties.

### CROSS-REFERENCE TO RELATED APPLICATION

This application claims priority to U.S. Provisional Patent Application No. 60/576,482, filed Jun. 3, 2004, the disclosure of which is incorporated by reference herein in its entirety, including drawings.

### BACKGROUND OF THE INVENTION

Traditionally, new materials have been discovered through test-and-trial methods. Basically, a chemist or a material science researcher synthesizes and characterizes a molecule with potentially desired features followed by tests of the molecule to determine if the desired properties have been met. If it not, as is usually the case, a new molecule is synthesized and the process repeated. This process, from initiation to discovery of a molecule with desired properties that can be moved from research to development, can usually requires several researchers and can take a few years. This is very expensive as the typical research costs, excluding specialized equipment about $300,000.00 per man-year. In the case of desired materials that lead to fundamental changes and improvements, a high degree of novelty and invention are typically required. In these cases, as the scientific basis for discovery is generally not fully in place (or the discovery would have been made), the costs can be very difficult to predict and be enormously high. These considerations can be exemplified by the requirements to discover homogeneous catalysts with specific functions. However, it is understood that the challenges and methodologies described can be applied to the discovery or improvement of almost any material amenable to theoretical study.

In the area of homogeneous catalysis for the conversion of a reactant to a desired product, an efficient commercially viable catalyst must simultaneously meet a minimum of three requirements related to a catalyst: Rate, Selectivity and Stability. Each of the requirements is controlled by the energetics of the catalyst with respect to three different activation barriers. Critically, since all of the requirements are influenced by the catalyst elemental composition, structure and co-reactants such as solvents and other reactants, it is extremely time consuming, expensive and improbable to identify a single catalyst composition/structure/co-reactant system that simultaneously meets all three requirements. The primary reason for this is that the state of the art of catalysis design is such that there is not sufficient knowledge of the factors that control Rate, Selectivity and Stability. Consequently, these catalyst requirements have traditional been achieved by the empirical, iterative, cyclical process of catalyst synthesis, characterization and testing until a likely candidate can be identified. There is much “art” to this iterative empirical process. Due to the challenges, especially in synthesis and characterization, this is very time consuming and expensive process that can require many man-years. In the case of the discovery of catalysts with efficiencies that have never been achieved before, the science base is more poorly developed and the degree of empiricism or guess-work is much higher leading to substantially higher costs and time. Thus, it is extremely difficult to find the right combination to develop right catalyst molecule based on the test-and-trial method.

Because of the complexity of molecular synthesis, another rate limiting effort of new catalyst development is to synthesis new catalyst. Thus, a smart method to design the new catalyst before it synthesized is a key. The method developed here will significantly change the way of our traditional method of catalyst development.

In 1995, Dr. Peter Schultz developed a combinatory material research tool to synthesize an array of new molecules and identify the properties of all the molecules in the array. This method has been said to significantly increase the speed of the discovery of new materials and substantially reduce the cost of research as well. However, the methods have drawbacks. For example, it did not solve the issue of rate limiting step of new catalyst synthesis. Although it did reduce the catalyst screening time, the fundamental issue of empirical approach of synthesis, which is a rate limiting step in many cases of catalysis and material development, is not addressed. The combination material research method, due to the empirical nature of the technique, may not allow for a focus on the key performance variables for the material being sought with the result that: A) potential targets may be overlooked that lead to misdirection and de-emphasis of potential catalyst candidates and B) non-optimum screens may be developed based on what is suitable for rapidity rather than screens based on a detailed molecular understanding of the underlying chemical principals of the chemistry being sought. This general reliance on rapidity without a commensurate degree of molecular understanding is particularly prone to the generation of excessive amount of data without a sufficiently accurate basis for which leads to follow.

Therefore, there is a need to continue develop novel material discovery method based on greater intelligence while retaining speed in the evaluation of possible systems before the more expensive and time consuming, materials synthesis, characterization and testing work begins. In recent years, molecular modeling technology becomes an increasingly important tool for catalysis and material development. This technology can be used to gain a fundamental understanding of chemistry by calculating molecular properties, reaction mechanisms and other important properties. However, there is lack of a systematic integrated approach in which the modeling is work is tightly integrated with experimental effort to shorten the discovery and developmental efforts leading to the production line. Therefore, methods according to the present invention will outline a new product development strategy that relies on the tight and efficient integration of modeling with experimental approaches to product development. The method according to the present invention will significantly shorten the product development time, enhance our ability to do high throughput screening using modeling technology coupled with experimental verification and, therefore, fundamentally change new product development strategies for R&D companies.

### SUMMARY OF THE INVENTION

One aspect of the invention relates to the use of computational technology to design, screen and discover the target molecules. To integrate a more fundamental basis for guiding the research, we begin by using existing experimental data to calibrate the computational model. Based on this calibrated model, we can use modeling tool to screen large number of potential targeted molecules for various molecular properties that are fundamentally required to meet the required performance. The experimental chemist then can synthesize some of those molecules screened from computational tool. After testing the performance of those candidates, the results will feedback to the modeling and improve modeling accuracy.

Another aspect of the present invention is directed to a method of discovering or developing a novel material which comprises the steps of: 1) providing a target molecule or a molecule subject to discovery; 2) defining a list of desirable properties; 3) using expert knowledge to develop a list of molecular properties that are critical to the performance of the material; 4) selecting or designing a computerized model that can provide a basis for determining whether test molecules can meet the molecular properties 5) designing a set of testing molecules that meet the desires molecular properties using the computational model; 6) synthesizing and characterizing the testing molecules; 7) testing the testing molecules in validation experiments in a manner that can provide information on the key molecular properties deemed to be important; and 8) identifying the testing molecules having the desirable properties or having properties close to the desirable properties.

Another aspect of the present invention is directed to a method of discovering or developing a novel material which comprises the steps of (1) through (8) as above-mentioned steps and further comprises a step of collecting the information about the testing molecules following step (7), adjust any or combined steps of the above steps (1) through (5) based on the information, and repeat steps (1) though (8) until a testing molecule with desired properties is identified. In a preferred embodiment, the information from step (7) is used to select a testing molecule to be a second target molecule and repeat steps (1) to (8) until a testing molecule with desirable properties is identified. In another preferred embodiment, the information from step (7) is used to re-define the desired properties of steps (2) or (3) and repeat steps (1) through (8) until a testing molecule with desirable properties is identified. In another preferred embodiment, the information is used to modify or redesign the computation method in step (4) to improve the accuracy of the computational model.

More particularly, materials which can be tested or prepared using the methods of the present invention include, for example, inorganic materials, intermetallic materials, metal alloys, ceramic materials, organic materials, organometallic materials, organic polymers, biological materials, and composite materials (e.g., inorganic composites, organic composites, or combinations thereof).

In a preferred embodiment, a target molecule is an organic molecule, an inorganic molecule, an organometallic compound, a metal, a metal oxide, a zeolite, a polymeric material, or a mixture of above. In a more preferred embodiment, a target molecule is a catalyst that facilitates chemical reactions.

In another preferred embodiment, the properties of a material (or a molecule or a compound) include, for example, electrical, thermal, mechanical, morphological, optical, magnetic, chemical, or other properties. The desired properties or desirable properties include heat resistance, conductivity, light emission, reaction temperature, resistance to poison, the ability of forming a self assembled monolayer, physical and chemical absorptions. In a more preferred embodiment, the desired properties include the ability of providing the lower activation energy barrier or providing the lower energy of key intermediate state of the reaction.

In another preferred embodiment, a computational method includes, but is not limited to, (1) quantum chemistry (e.g., Hartree-Fock or Density Functional Theory), (2) semi-empirical, (3) molecular dynamics, in particular using reactive force field, (4) monte-carlo approaches, and (5) qualitative structure property correlation (QSPR) method.

In another preferred embodiment, once testing molecules are identified through computation methods, the molecules can be synthesized based on the traditional synthetic chemistry method. The synthesized molecule then can be also tested based on real life experiment (not computational experiment) by using micro reactors routinely used in the laboratory.

These embodiments can be illustrated by examples that relate to the identification or development of novel catalysts for selective, low temperature hydrocarbon conversion to useful products.

### BRIEF DESCRIPTION OF THE DRAWINGS

FIG. 1 shows a discovery workflow that represents a general scheme of the present invention.

FIG. 2 shows the general scheme for the Operation of a CH activation based catalyst for the conversion of methane to methanol.

FIG. 3 shows the chemical structure of (acac)₂Ir(OMe)(L) complexes (L=methanol).

FIG. 4 shows DFT calculations of the (NNC)Ir(OH)₂(H₂O) system showing feasibility for CH activation.

FIG. 5 shows the chemical structure of (NNC)Ir(X)(X)L complexes.

FIG. 6 the chemical structure of the hexaflouro analogue of (acac)₂Ir(Ph)(L).

FIG. 7 shows the (trop)₂Ir(Ph)(L) analogue of the (acac)₂Ir(Ph)(L) catalyst.

FIG. 8 shows the theoretical calculations indicating that the (trop)₂Ir(Ph)(L) would not be expected to be more active than the (acac)₂Ir(Ph)(L) for Hydroarylation.

FIG. 9 shows catalysts based on the N₂O₂ ligand motif with Ir.

FIG. 10 shows theoretical calculations of the N₂O₂Ir system showing feasibility for CH activation.

### DETAILED DESCRIPTION OF THE INVENTION

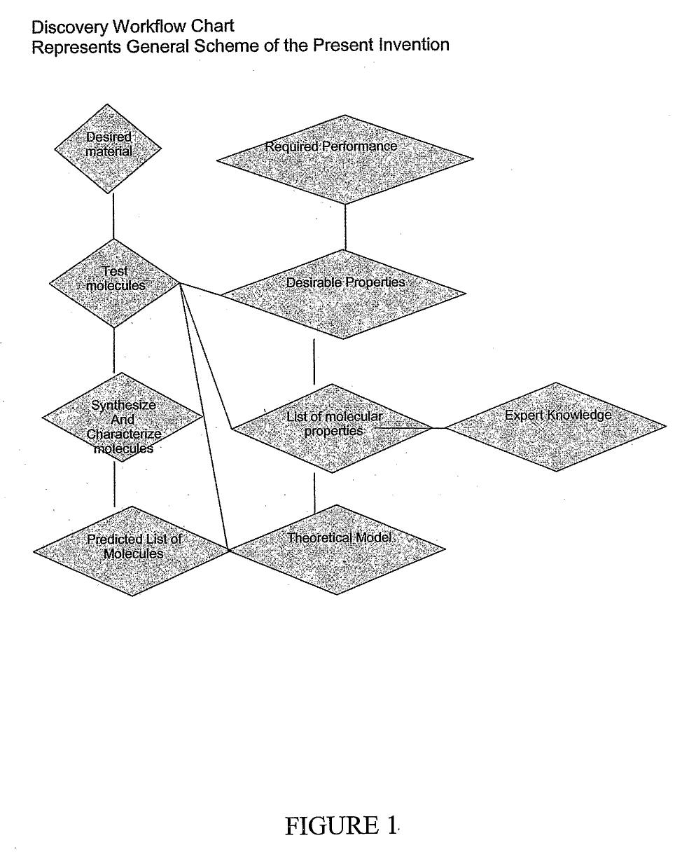

One aspect of the present invention is directed to a method of discovering or developing a novel material which comprises the steps of: 1) providing a target molecule or a molecule subject to discovery; 2) defining a list of desirable properties; 3) using expert knowledge to develop a list of molecular properties that are critical to the performance of the material; 4) designing a calibrated molecular model that can provide a basis for determining whether test molecules can meet the molecular properties 5) designing a set of testing molecules derived using the computational method that meet the desired molecular properties; 6) synthesizing and characterizing the testing molecules; 7) testing the testing molecules in validation experiments in a manner that con provide information on the key molecular properties deemed to be important; and 8) identifying the testing molecules having the desirable properties or having properties close to the desirable properties; 9) using the experimental information to improve the accuracy of the theoretical model and repeating the iterative process. FIG. 1 shows a general scheme of the embodiment of the present invention.

Target molecules referred herein means compounds or materials, e.g., solid state compounds, extended solids, solutions, clusters of molecules or atoms, crystals. More particularly, materials which can be prepared using the methods of the present invention include, for example, inorganic materials, intermetallic materials, metal alloys, magnetic alloys, ceramic materials, organic materials, organometallic materials, organic polymers, biological materials, and composite materials (e.g., inorganic composites, organic composites, or combinations thereof).

In a preferred embodiment, a target molecule is an organic molecule, an inorganic molecule, an organometallic compound, a metal, a metal oxide, a zeolite, a polymeric material, and a mixture of above. In a more preferred embodiment, a target molecule is a catalyst that facilitates chemical reactions.

In providing a target molecule, general expert knowledge is used to identify currently available molecules, key reactions or features of a problem that is currently unsolved.

For example, it has been a challenge of developing more efficient catalysts for the direct, low temperature, selective conversion of saturated hydrocarbons to alcohols and other functionalized products with high atom and energy efficiency. Current catalysts operate at high temperatures and are not energy and atom inefficient. This leads to high capital, excessive pollution and high operating costs. Therefore, a catalyst may become a candidate subject to the discovery or development methods describe herein.

The properties of a molecule (or material or a compound) include, for example, electrical, thermal, mechanical, morphological, optical, magnetic, chemical, or other properties. The properties of an molecule include, but are not limited to, color, freezing point, boiling point, melting point, decomposition temperature, paramagnetic to magnet, diamagnetic to magnet, opacity, viscosity, density, conductivity (ionic, electrical and thermal), vapor pressure, surface tension, heat capacity, coefficient of thermal expansion, thermal stability, glass transition temperature, empirical solvent parameters, absorption, hardness, acidity (e.g., Brónsted, Lewis, and Flanklin acidity), toxicity, biological effect, environmental effect, electromotive force, electrochemical window, dielectric constant, dipole moment, refractive index, luster, malleability, hydrophobicity, ductility, piezoelectricity, electrostrictivity, solubility to variety of chemicals and solvents, miscibility to variety of matters (e.g., water and air).

In a preferred embodiment, the desired properties or desirable properties include heat resistance, conductivity, light emission, reaction temperature, resistance to poison, the ability of forming a self assembled monolayer, physical and chemical absorptions. In a more preferred embodiment, the desired properties include the ability of providing the lower activation energy barrier or providing the lower energy of key intermediate state of a reaction.

The desired properties of a candidate catalyst molecule would include a reaction rate for the conversion of, for example, methane to methanol, specified by a catalyst Turn Over Frequency (TOF) of ˜1 s¹, a product selectivity to methanol of >95% and a catalyst life specified by the Turn-Over-Number (TON) of >10⁵. In the example of developing a catalyst for the direct (without the intermediate formation of syngas), selective, low temperature conversion of carbon-hydrogen (CH) bonds of alkanes to C—OH bonds (alkane hydroxylation), a key consideration to designing a more effective catalyst system is that in some manner the catalyst must lower the energy requirements for conversion of alkanes to alcohols while simultaneously increasing the barrier to conversion of the alcohol to undesired side products. The CH activation reaction is a particularly mild reaction, whereby the CH bond can be cleaved under low temperature conditions (<300 C) by a catalyst (LMX) and replaced by a LM-C bond that can be more readily converted to the desired product, in this case an alcohol, with regeneration of the catalyst LMX. Uniquely, in addition to being facile, the CH activation reaction can be quite selective and, unlike classical oxidation reaction systems, saturated hydrocarbons can be more reactive than the desired alcohol or other functionalized products. This is the key to develop high selectivity reactions. In many cases, the catalyst is a transition metal but this need not be the case.

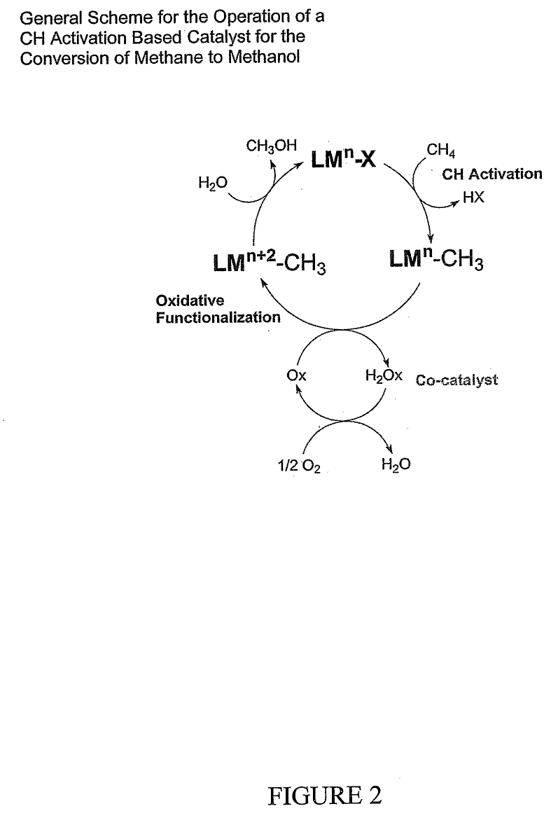

Although the CH activation reaction has been known for over a decade, only relatively few direct, selective, low temperature catalyst systems have been developed for the conversion of hydrocarbons based on this reaction. Study of these references show that the systems follow the general reaction sequence shown in FIG. 2. The activation of the CH bond followed by conversion of the LM-C species to the desired product and the catalyst LMX.

After a candidate molecule is selected and desired properties are defined, the candidate molecule are designed or modified through computational methods, which include, but are not limited to, quantum chemistry (for Density Functional Theory (DFT), see P. Hohenberg and W. Kohn, Phys. Rev. B 136 864 (1964); W. Kohn and L. J. Sham, Phys. Rev. A 140 1133 (1965); for Hartree-Fock (HF), see D. R. Hartree, Proc. Cam. Phil. Soc. 24 426 (1928), V. Fock, Z. Phsik 61, 126 (1930); for semi-empirical (Austin Model 1 (AM1)), see H. J. S. Dewar, E. G. Zoebisch, E. F. Healy and J. J. P. Stewart, J. Am.; Chem. Soc. 107 3902 (1885); for Parametric Method 3 (PM3), see J. J. P. Stewart, J. Comput. Chem. 10 209, 221 (1989); for molecular dynamics, in particular, using reactive force field (e.g., MM3), see J. H. Li and N. L. Allinger, J. Am. Chem. Soc. 111 8566-8575; 111 8576-8582; for ReaxFF, see A. C. T. van Duin, S. Dasgupta, F. Lorant, W. A.Goddard III, J. Phys. Chem. A 105, 9396 (2001); A. C. T. van Duin, A. Strachan, S. Stewman, Q. Zhang, X. Xu, W. A., Goddard III, J. Phys. Chem. A 107 3803-3811 (2003); for monte-cario approaches, see Metropolis, Nicholas and Stanislaw Ulam, The Monte Carlo Method, J. of Am. Stat. Association, 44 (247) 335-341 (1949); for Quantitative Structure-Activity Relationship (QSAR), and Qualitative Structure-Property Correlation (QSPR) Methods, see M. Karelson, Molecular Descriptors in QSAR/QSPR, John Wiley & Sons, Inc. (2000).

For example, in modifying a catalyst based on the CH activation reaction, theoretical use of DFT methods is critical to the identification of more effective catalysts. An important aspect of modeling this CH activation step is the realization that this reaction is a coordination reaction requiring coordination of the hydrocarbon to the first coordination sphere of the atom, M, that is involved in generating the M-C intermediate during catalysis. Saturated hydrocarbons are poor ligands and critically, the species in the reaction system that binds tightest to the catalyst will play a key role in determining the energy required to break the CH bond and generate the LM-C intermediate. Thus, modeling the net reaction LM-Y+CH→LM-C+HY where Y is the species in the reaction systems that binds the tightest to the catalyst is a key step to model by DFT calculations. This is in contrast to modeling LMX+CH→LM-C reaction where LMX is what is the complex introduced into the reaction mixture. In this case, the species X may not be the species that will bind the tightest to LM and consequently, is not the appropriate species to be used in the modeling. In the modeling process, an important step is to determine which species in the reaction system, will bind the tightest to LM fragment. This can be accomplished by comparing the equilibrium between the various possible binding species, e.g. X, Y and Z by the sequence of reaction LMX+Y→LMY+X and LMX+Z→LMY+X to determine the most stable LM species. In modeling this reaction, the objective is to identify LM-Y species (by varying M and the ligands L) that have the lowest barrier for the CH activation reaction with hydrocarbons with practical examples of Y such as H₂O, CH₃CO₂H, CH₃OH, etc.. This can be done by determining the calculated energy of the highest energy transition state during the CH activation reaction relative to the ground state, where the ground state is LMY and the CH bond containing species. As calculations of transition state energies can be time-consuming a useful first pass approximation is to determine the calculated energy of the LM-C species relative to the ground state. In general, the goal is to identify improved catalysts (with various M, L and Y combinations) with energy barriers lower than, for example, 30 kcal/mol, as catalysts with such barriers would operate at desirable rates below 300° C.

In addition to modeling LMY species for low barriers for reaction with the CH substrate, it is important that the LMY species react with the desired product of the reaction, e.g. CH₃OH, less rapidly than with the starting material CH. Consequently, in addition to testing candidates for low barriers to reaction with CH, ideal candidates will also show higher barriers to reaction with CH₃OH products.

Further refinement of candidate molecules can be made through consideration of the undesirable reactions of LMY species, as any such reactions will lead to higher reaction barriers. A typical reaction is the reaction of LMY with the oxidant in the system. An oxidant, O2, Cu(II), etc. is required for the conversion of CH to COH, for thermodynamic reasons. Thus, if the reaction of LMY with the oxidant is faster than reaction with CH to generate e.g., LMⁿ⁺²Y, this may be undesirable. However, this reaction of the oxidant with LMY does not necessarily rule out the use of LMY as a catalyst if the oxidized species, e.g., LMⁿ⁺²Y can be rapidly reduced by reaction with the LM-C intermediate during catalysis. These types of reaction can all be studies by DFT and used to identify likely improved catalyst candidates.

Another aspect of the computation modeling is to combine considerations of what can be made (based on knowledge to those skilled in the art of synthesis of organometallic and inorganic coordination complexes) in selecting candidates catalysts to be tested with the theoretical model for low barriers for the CH activation reaction. Other important considerations are which molecules could be expected to be stable to the reaction conditions for oxidizing the hydrocarbon. In some cases, if the possible decomposition reactions of the catalyst can be identified, these reactions can be examined by theoretical calculations to identify catalysts that are likely to be stable and active.

After computation modeling provide a set of test molecules that may have desired propertied based on computation, these molecules are then synthesized and tested in real-life experiment, and the properties of the test molecules are measured. In general the choice of molecules to synthesis will be based on the relative ranking of molecules that the theoretical calculations show to have the lowest barriers for reaction combined with consideration of the ease of synthesis of the molecules and other factors such as catalyst stability. Additional considerations such as which catalysts are likely to be most selective will also be taken into account. In the example of developing catalysts for CH activation, the candidate catalysts from the computation modeling is then synthesized and tested for the CH activation and conversion of saturated hydrocarbons. A typical test can be carried out by reaction of the hydrocarbon with a deuterium source in the presence of the catalyst in order determine if deuterium has been incorporated into the hydrocarbon. Because this reaction is reversible and reaction with a deuterium source D-Sol+LM-C+Y can lead to the formation of C-D, conversion of LMY+CH→LM-C+Y is tested. If this occurs, the rate of formation of C-D is a test for the efficiency of the catalyst. In some cases, this may not be possible as the LM-C species could react as fast rates to generate functionalized C-Z species irreversibly.

Typically, a testing molecule in real experiment may not perform as predicated in the computational model. In this event, the information as to why the testing molecule does not perform will be collected and used to identify new candidate molecule, redefine properties or modify the computational method.

For example, when a testing catalyst fails to perform as desired and the rate of the C-D formation may not be as high as expected. In these cases, it is important to determine why this is the case. There could be several reasons for example, A) the catalyst is decomposing under the reaction conditions, B) the formation of LM-C is irreversible, C) the reaction is not proceeding due to a competitive reaction, and D) the actual barriers are higher than the calculated barriers. These can be distinguished by experiment and used to refine the model. If the catalyst is unstable then new candidates can be tested. If the formation of LMC is irreversible then a new test reaction will be chosen for testing. If competing reactions are an issue, these must be identified and taken into consideration into the theoretical model. If the experimental barriers are higher than calculated then adjustments must be made to the theoretical model to more accurately predict the actual barrier.

Advantages. The advantages of using this theory/experimental iterative process are that the experimental efforts can be focused. For example in the area of developing hydrocarbon oxidation catalysts based on CH activation reaction, if solvent inhibition is not considered, the catalyst could look promising and require time and resource to investigate but eventually fail to meet the catalyst targets. This is because there are many solvents that could lead to active catalysts for the CH activation reaction that can be predicted on the basis of expert knowledge, not to be practical for commercial use. The issue is that the catalyst structures that will operate at an optimum in such solvents cannot be made to operate efficiently in practical solvents because the molecular processes may be unique to the solvent utilized. Without such knowledge, the typical course taken in research is to follow any lead with the expectation that at some later stage that the catalyst can be modified to meet practical targets. This is essentially what is done in almost all research today. Researchers often work on systems because they show the best current performance without regard to whether the target can be eventually identified. Of course under these circumstances it can be predicted that almost all the effort will most likely lead to failure. However, if the experimental research can be coupled with expert knowledge and a theoretical evaluation of all systems, regardless of the current performance, some fundamental requirements for eventual success can be determined and priorities can be set from such a study. In this case, the unexpected result can be that the species currently showing a poor performance may have desirable properties for overall success.

### EXAMPLES

### Example 1

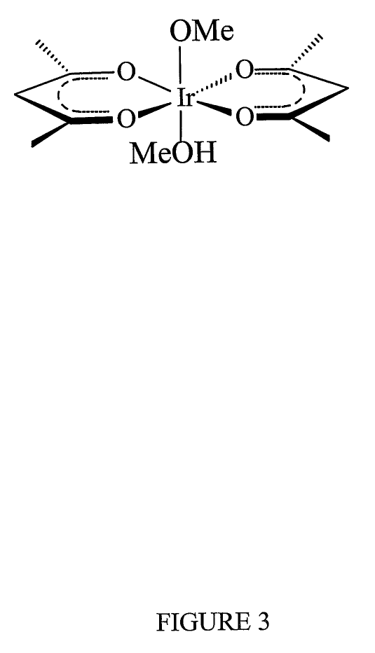

On the basis of expert knowledge, a series of catalysts were identified for the hydroarylation of olefins that proceed via the CH activation of the arene. In studying these catalysts by DFT calculations, we identified that the reaction of (acac)₂Ir(OMe)(L) complexes (L=pyridine or methanol) (See FIG. 3 as L=methanol) could be expected to react with benzene in a favorable thermodynamically downhill reaction to generate the (acac)₂Ir(Ph)(L) CH activation intermediate with barrier of ˜30 kcal/mol. While on the basis of expert knowledge this general reaction was expected, it was not expected that this reaction would be so favorable. Importantly, subsequently experiment confirmed the theoretical calculations that this reaction was efficient and favorable.

### Example 2

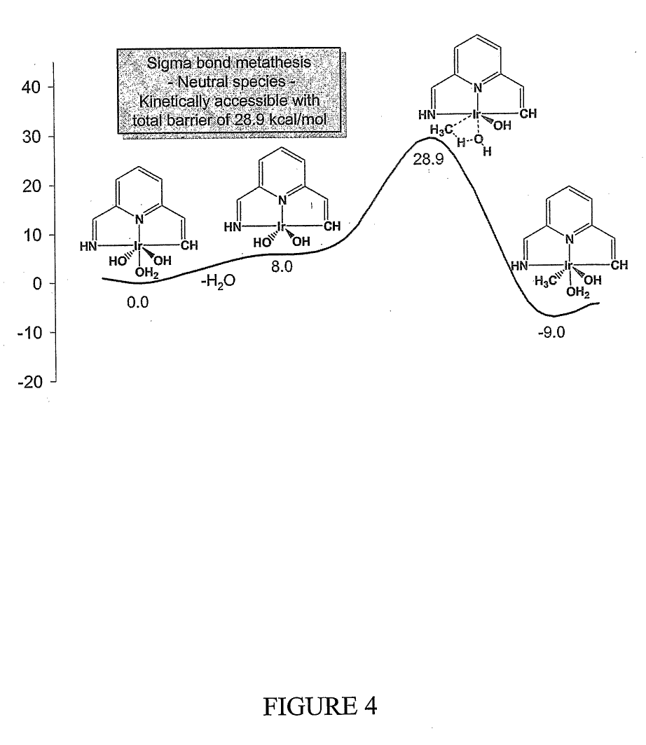

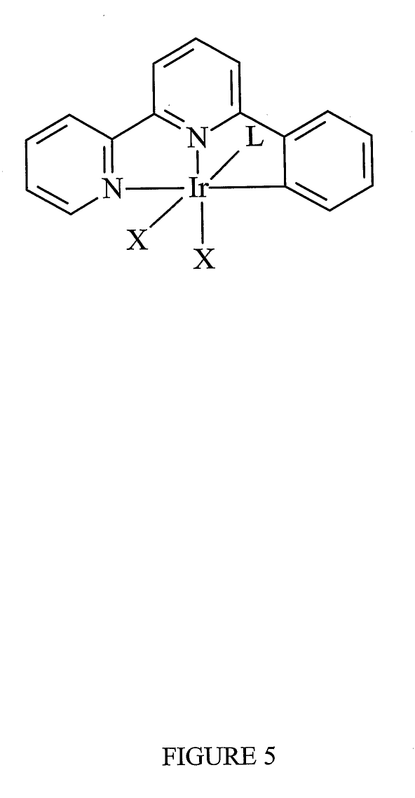

On the basis of expert knowledge and the observed reactivity of the Pt(k²-bipyrimidine)Cl₂ and Hg(II) in strong acid solvents, it was predicted that increasing the electron density at the metal centers of metal such as Pt(II) and Ir(III) could be expected to lead to catalysts that would not require strong acid solvents for reaction. This would be advantageous since the presence of strong acid solvents make these catalysts impractical with regard to product separation. It was reasoned that increasing the electron density at the metal centers would decrease the binding of the catalyst to solvent molecules without correspondingly increasing the transition state for the CH activation reaction. However, there are many ways of increasing the electron density of these metals with a variety of ligands that could be expected to stable and it would be prohibitively expensive to synthesize, characterize and study of the predicted systems experimentally. By the use of DFT calculations (See FIG. 4) we were able to quickly focus our efforts on the use of (NNC)Ir(X)(X)L complexes of the general structure as shown in FIG. 5. This was an important prediction as the goal was to synthesize the easier to produce symmetrical (NCN)M(X)(X)(L) systems. However, the theoretical calculations showed that the (NCN)Ir complex would be expected to show higher barriers for reaction than the (NNC)Ir system. We have now succeeded in the synthesis of the (NNC)Ir(X)(X)(L and have begun to observed CH activation reaction where X is CH₃CO₂ and CF₃CO₂. Importantly, as predicted by the DFT calculations these observed activity for the CH activation reaction is higher than that for the most efficient catalyst known Pt(bpym)Cl₂ in these solvents.

### Example 3

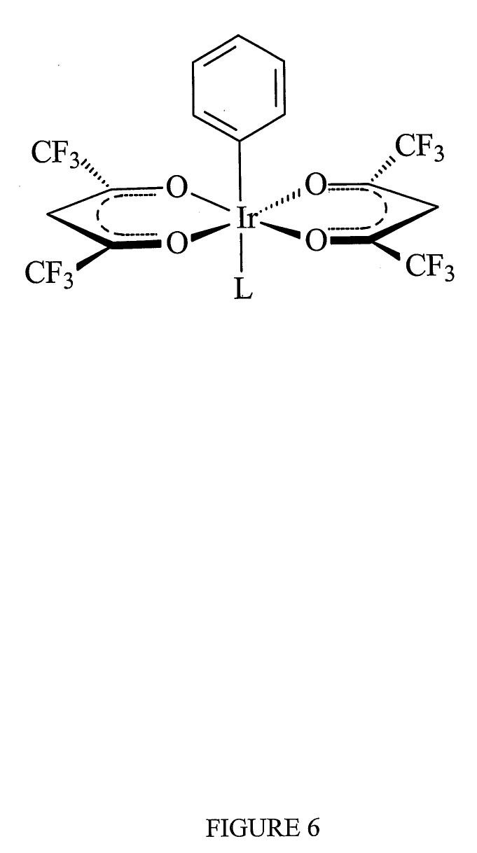

Theoretical calculations indicate that the hexaflouro analogue of (acac)₂Ir(Ph)(L) (FIG. 6) should be a more efficient catalyst for hydroarylation of olefins. While on the basis of expert knowledge, we anticipated that electron withdrawing fluorine groups may facilitate olefin insertion into the Ir-Ph bond. However, it was difficult to determine if this would lead to net increase or decrease in efficiency. The results from the syntheses of the hexafloro complex indicate that this complex is indeed more efficient, which corresponds to the predication by theoretical calculations.

### Example 4

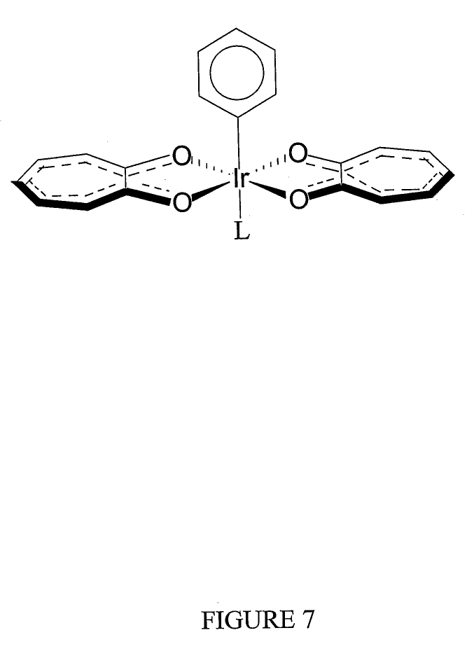

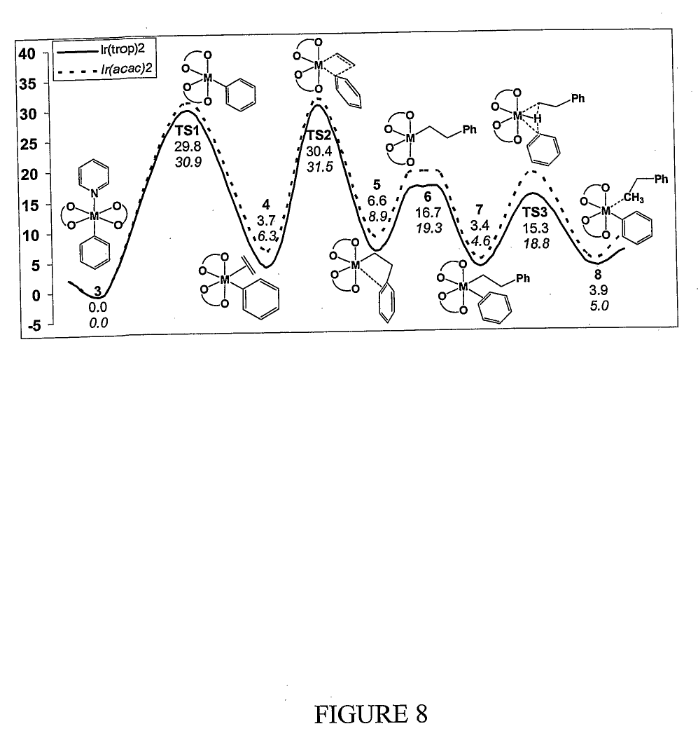

On the basis of experimental results, we found that the (trop)₂Ir(Ph)(L) analogue (FIG. 7) of the (acac)₂Ir(Ph)(L) catalyst was more efficient for CH activation. On the basis of this result, we assumed that it was possible for this catalyst to also be more efficient for the hydroarylation reaction. However, theoretical calculations indicated that this catalyst should comparable overall activity for hydroarylation (See FIG. 8). Subsequently, experimental work confirmed the theoretical calculations.

### Example 5

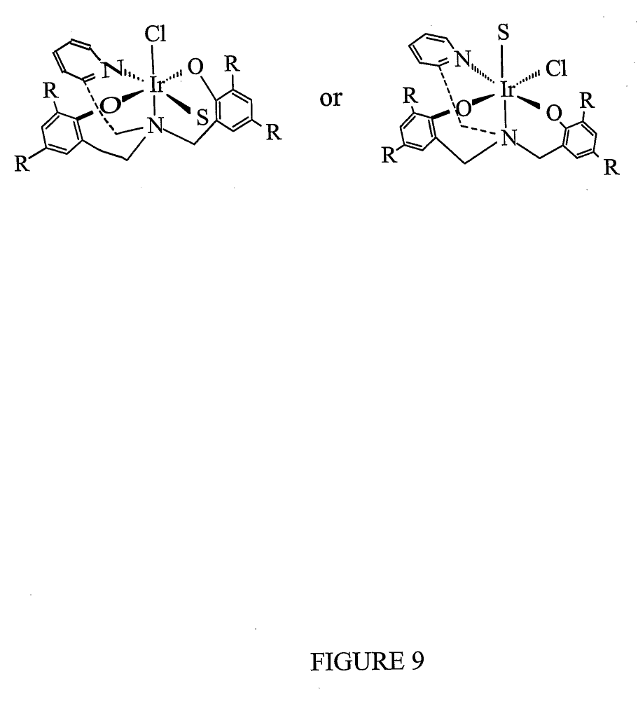

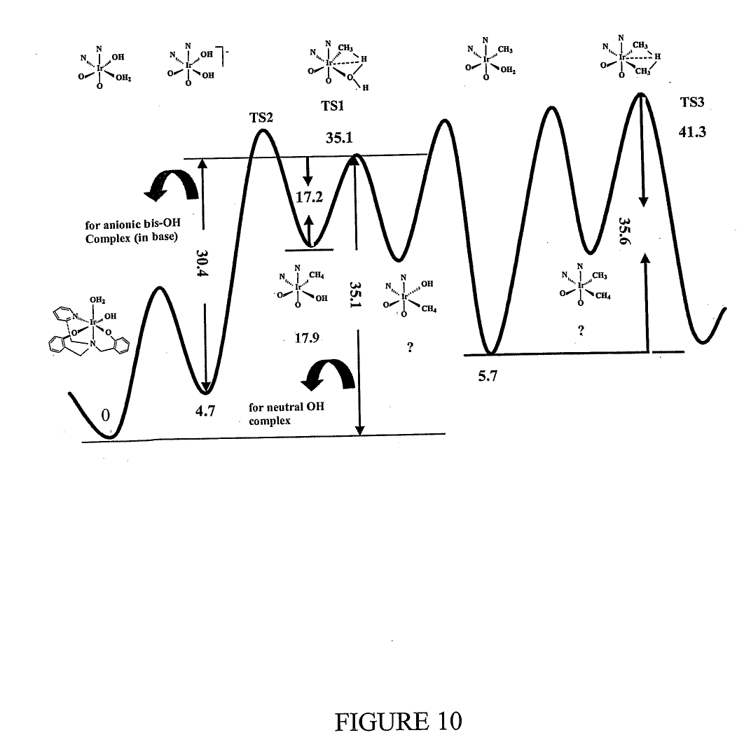

On the basis of the stability of O-donor late transition metal complexes and the observed activity for CH activation, e.g. the (acac)₂Ir(P)(L) system (FIG. 9), it seemed desirable to explore other O-donor ligated systems. However, as a result of the wide variety of possible systems that could be explored we turned to theoretical calculations to help identify complexes that could be readily synthesized and that could be expected to show activity for CH activation. After exploring many examples by the protocols described above, one of the classes of catalysts identified were based on the N₂O₂ ligand motif with Ir. Calculations (FIG. 10) showed that these complexes could be expected to show the CH activation reaction barriers of ˜30 kcal/mol. We have now synthesized the first generation of these novel complexes and have confirmed that these complexes are active for the CH activation reaction.

What is claimed is:

1. A method of developing or identifying a new material comprising the steps of:
1) providing a target molecule subject to discovery;
2) defining a list of desired properties;
3) designing a set of testing molecules derived from the target molecule using a computational method to have the desirable properties;
4) synthesizing the testing molecules;
5) testing the testing molecules in validation experiments;
6) identifying the testing molecules having the desirable properties or having properties close to the desirable properties.

2. The method of claim 1 further comprising the steps of:
1) collecting information about the testing molecule from step (5) of claim 1,
2) modifying steps (1), (2) or (3) of claim 1 based on the information of the step (1) of claim 2, and
3) repeating the steps (1) through (6) of claim 1 until a molecule with desired properties is found.

3. The method of claim 1 wherein the computational method is selected from the group consisting of quantum chemistry, semi-empirical, molecular dynamics, in particular using reactive force field, monte-carlo approaches, and qualitative structure property correlation (QSPR) method.

4. The method of claim 1 wherein the target molecule is selected from the group consisting of inorganic material, intermetallic material, metal alloy, ceramic material, organic material, organometallic material, organic polymer, biological material, and composite material.

5. The method of claim 1 wherein the target molecule is an organic molecule, an inorganic molecule, an organometallic compound, a metal, a metal oxides, a zeolite, a polymeric material, or a combination thereof.

6. The method of claim 1 where in the target molecule a catalyst that facilitates a chemical reaction.

7. The method of claim 1 wherein the desired properties are selected from the group consisting of heat resistance, conductivity, light emission, reaction temperature, resistance to poison, the ability of forming a self assembled monolayer, physical and chemical absorptions, and any combination thereof.

8. The method of claim 1 wherein the desired properties are the ability of providing the lower activation energy barrier or providing the lower energy of key intermediate state of a reaction.
